(19) United States
(12) Patent Application Publication
(10) Pub. No.: US 2016/0097658 A1
(43) Pub. Date: Apr. 7, 2016

(54) FIBER OPTIC IMPLEMENT POSITION DETERMINATION SYSTEM

(71) Applicant: Caterpillar Inc., Peoria, IL (US)

(72) Inventors: Paul R. Friend, Morton, IL (US); Kenneth L. Stratton, Dunlap, IL (US)

(73) Assignee: Caterpillar Inc., Peoria, IL (US)

(21) Appl. No.: 14/506,896

(22) Filed: Oct. 6, 2014

(51) Int. Cl. G01D 5/26; G01B 11/16; G01B 11/24

(52) U.S. Cl. CPC G01D 5/268; G01B 11/24; G01B 11/18

(57) ABSTRACT

A system for determining the orientation of an implement relative to a frame of a machine is provided. The implement is attached to and moveable relative to the machine. A fiber optic shape sensing system is associated with the implement. The fiber optic shape sensing system provides the position and orientation of the implement relative to a reference frame that is fixed to the machine frame.

### TECHNICAL FIELD

This disclosure relates generally to an implement control system for a machine, and more particularly to systems and methods for determining a position on an implement relative to a reference position on the machine.

### BACKGROUND

Earthmoving machines such as track type tractors, motor graders, scrapers, and/or backhoe loaders, have an implement such as a dozer blade or bucket, which is used on a worksite in order to alter a geography or terrain of a section of earth. The implement may be controlled by an operator or by a control system to perform work on the worksite such as achieving a final surface contour or a final grade on the worksite. Continuously positioning the implement with enough precision to achieve a final grade, however, is a complex and time-consuming task that requires expert skill and diligence if the operator is controlling the movement. Thus, it is often desirable to provide autonomous control of the implement to simplify operator control.

To control the implement autonomously, it is sometimes necessary to determine the accurate position of at least one point on the implement relative to a reference point on the machine. It is also sometimes necessary to determine the precise distance between at least one point on the implement and a reference point on the machine. Determining the accurate relative position and precise relative distance of a point on the implement and a reference point on the machine may require calibrating or updating an implement control system using the position and distance information.

Previous systems relied on sensors to determine the relative movement of each link that connects to the implement in order to determine the position and orientation of the implement. The relative movement of each link, such as a hydraulic cylinder, is sensed and communicated to a controller which then calculates the orientation of the implement. Such systems often need to be calibrated with the machine stationary on a flat surface each time the machine is started. Such systems are also dependent on the accuracy and robustness of each individual sensor.

Such a sensor is disclosed in U. S. Pat. No. 7,757,547 to Kageyama et al., issued Jul. 20, 2010, entitled “Cylinder stroke position measurement device,” discloses an apparatus for determining the stroke of a cylinder using a sensor wheel and a Hall effect sensor. The Kageyama apparatus however is susceptible to dirt that could cause binding or slipping of the sensor wheel. The Kageyama apparatus is further susceptible to hydraulic oil that could cause slipping of the sensor wheel which could cause an inaccuracy in the cylinder stroke measurement.

A system and method that more directly determines the position and orientation of an implement and is less susceptible to dirt and contamination is required.

### SUMMARY OF THE INVENTION

A system for determining a position and orientation of an implement relative to a frame of a machine is disclosed. The system comprises an implement being attached to and moveable relative to the machine and a fiber optic shape sensing system associated with the implement. The fiber optic shape sensing system comprises an interrogation module mounted to the machine frame, a reference frame fixed to the interrogation module and machine frame, and a fiber bundle joined to the interrogation module at a proximal end and to the implement at a distal end. The interrogation module is configured to receive strain information from the fiber bundle and compute the location of at least one position of the fiber bundle that is associated with the implement relative to the reference frame.

In a second aspect of the current disclosure, a method for determining the position and orientation of an implement relative to a frame of a machine is disclosed. The method comprises providing a fiber optic shape sensing system associated with the implement that comprises an interrogation module mounted to the machine frame, a reference frame fixed to the interrogation module and machine frame, and a fiber bundle joined to the interrogation module at a proximal end and to the implement at a distal end. The method further comprises receiving reflection spectrum information from the fiber bundle in the interrogation module, and computing the location of at least one position of the fiber bundle that is associated with the implement relative to the reference frame.

In a third aspect of the current disclosure, a machine equipped with a system for determining the position and orientation of an implement relative to a frame of the machine is disclosed. The machine comprises a power source, a ground engaging mechanism, an implement attached to and moveable relative to the machine, and a fiber optic shape sensing system associated with the implement. The fiber optic shape sensing system comprises an interrogation module mounted to the machine frame, a reference frame fixed to the interrogation module and machine frame, and a fiber bundle joined to the interrogation module at a proximal end and to the implement at a distal end. The interrogation module is configured to receive strain information from the fiber bundle and compute the location of at least one position of the fiber bundle that is associated with the implement relative to the reference frame.

### BRIEF DESCRIPTION OF THE DRAWINGS

FIG. 1 illustrates a side view of a machine having a fiber optic shape sensing system and an implement control system according to the current disclosure;

FIG. 2 illustrates a front view of a machine having a fiber optic shape sensing system and an implement control system according to the current disclosure;

FIG. 3 illustrates an implement control system according to the current disclosure;

FIG. 4 is a functional illustration of a fiber optic shape sensing system and an exemplary 3D shape representation according to the current disclosure;

FIG. 5 is a functional illustration of a fiber bundle according to the current disclosure;

FIG. 6 is a functional illustration of a machine having a fiber optic shape sensing system according to the current disclosure;

FIG. 7 is a functional illustration of a machine having a fiber optic shape sensing system according to the current disclosure;

FIG. 8 is a flow chart illustrating an implement position determination system according to the current disclosure.

### DETAILED DESCRIPTION

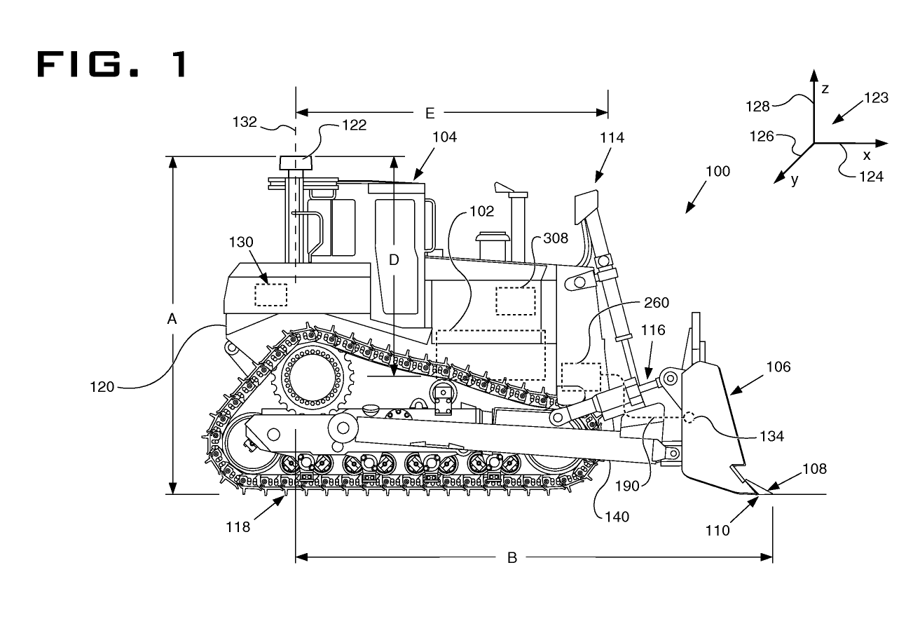

This disclosure relates to systems and methods for determining a position on an implement relative to a reference position on a machine. An exemplary embodiment of a machine 100 is shown schematically in FIG. 1. The machine 100 may be a mobile machine that performs some type of operation associated with an industry such as mining, construction, farming, transportation, or any other industry known in the art. For example, the machine 100 may be a tractor or dozer, as depicted in FIG. 1, a scraper, or any other machine known in the art. While the following detailed description of an exemplary embodiment describes the invention in connection with a dozer, it should be appreciated that the description applies equally to the use of the invention in other such machines.

In an illustrated embodiment, the machine 100 includes a power source 102, an operator's station or cab 104 containing controls necessary to operate the machine 100, such as, for example, one or more input devices for propelling the machine 100 and/or controlling other machine components. The machine 100 further includes an implement 106, such as, for example, a blade, a bowl, a ripper, or a bucket for moving earth. The one or more input devices may include one or more joysticks disposed within the cab 104 and may be adapted to receive input from an operator indicative of a desired movement of the implement 106. The cab 104 may also include a user interface having a display for conveying information to the operator and may include a keyboard, touch screen, or any suitable mechanism for receiving input from the operator to control and/or operate the machine 100, the implement 106, and/or the other machine components.

The implement 106 may be adapted to engage, penetrate, or cut the surface of a worksite and may be further adapted to move the earth to accomplish a predetermined task. The worksite may include, for example, a mine site, a landfill, a quarry, a construction site, or any other type of worksite. Moving the earth may be associated with altering the geography at the worksite and may include, for example, a grading operation, a scraping operation, a leveling operation, a bulk material removal operation, or any other type of geography altering operation at the worksite.

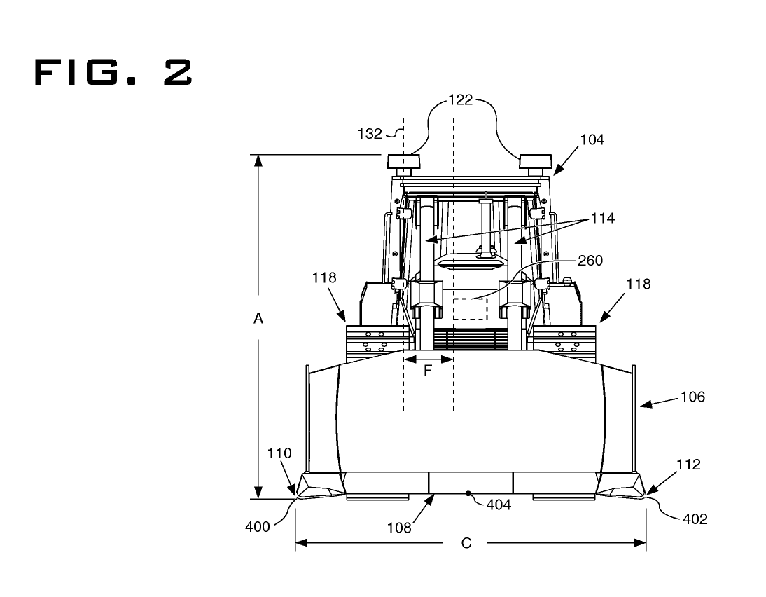

As illustrated in FIG. 1, the implement 106 is pivotally attached to the machine frame 120 by push arms 140. The implement 106 includes a cutting edge 108 that extends between a first edge 110 and a second edge 112 (best shown in FIG. 2). The first edge 110 of the cutting edge 108 of the implement 106 may represent or define a right tip or right edge of the implement 106 and the second edge 112 of the cutting edge 108 of the implement 106 may represent or define a left tip or left edge of the implement 106. The implement 106 may be moveable by one or more hydraulic mechanisms operatively connected to the input device in the cab 104.

The hydraulic mechanisms may include one or more hydraulic lift actuators 114 and one or more hydraulic tilt actuators 116 for moving the implement 106 in various positions, such as, for example, lifting the implement 106 up or lowering the implement 106 down, tilting the implement 106 left or right, or pitching the implement 106 forward or backward. In the illustrated embodiment, the machine 100 includes one hydraulic lift actuator 114 and one hydraulic tilt actuator 116 on each side of the implement 106. The illustration in FIG. 2 shows two hydraulic lift actuators 114, but only one of the two hydraulic tilt actuators 116 is shown (only one side shown). In another aspect of the current disclosure, the machine 100 may be equipped with a variable pitch, angle, tilt (VPAT) implement 106 configuration. In a VPAT configuration, the implement 106 is pivotally attached to machine frame 120 or an intermediate member thereof. The VPAT configuration may have hydraulic angle actuators 117 to control the yaw angle of the implement 106 relative to the machine frame 120 of the machine 100.

The power source 102 is an engine that provides power to a ground engaging mechanism 118 adapted to support, steer, and propel the machine 100. The power source 102 may embody an engine such as, for example, a diesel engine, a gasoline engine, a gaseous fuel-powered engine, or any other type of combustion engine known in the art. It is contemplated that the power source 102 may alternatively embody a non-combustion source of power (not shown) such as, for example, a fuel cell, a power storage device, or another suitable source of power. The power source 102 may produce a mechanical or electrical power output that may be converted to hydraulic power for providing power to the machine 100, the implement 106, and to other machine 100 components.

The machine 100 further includes a frame or machine frame 120 disposed between the implement 106 and the ground engaging mechanisms 118. A position determining system 122 adapted to receive and process position data or signals may be mounted to the machine frame 120 of the machine 100. The position determining device 122 may be a global position satellite (GPS) system receiver. The GPS receiver, as is well known in the art, receives signals from a plurality of satellites and responsively determines a position of the receiver in a site coordinate system 123 relative to the worksite, that is, in a site coordinate system. The site coordinate system 123 may be a Cartesian system having an x-coordinate 124, a y-coordinate 126, and a z-coordinate 128. In alternative embodiments, the position determining system 122 may include other types of positioning systems without departing from the scope of this disclosure, such as, for example, laser referencing systems. The position determining device 122 may include two or more GPS receivers without departing from the scope of the current disclosure. Locations of multiple GPS are fixed and known and their locations may be provided to the controller 304 and fiber optic shape sensing system 260.

The machine 100 further includes an implement control system 130 operatively connected to the input device and to the hydraulic actuators 114, 116 for controlling movement of the implement 106. The control system 130 may direct the implement 106 to move to a predetermined or target position in response to an operators' desired movement of the implement 106 for engaging the implement 106 with the terrain of the worksite. The control system 130 may further direct the implement 106 to move to a predetermined or target position indicative of an automatically determined movement of the implement 106, based in part on, for example, an engineering or site design, a productivity or load maximizing measure, or a combination of site design and productivity measure.

To direct the implement 106 to move precisely in response to an automatically determined movement signal or command, the control system 130 may require certain predetermined measurement data associated with the machine 100 and may need to perform certain predetermined calibrations on other systems and components associated with operating the machine 100. As illustrated in FIGS. 1 and 2, the machine 100 includes a vertical dimension measurement A, a first horizontal dimension measurement B, which is defined within a plane orthogonal to or perpendicular to the plane within which the vertical dimension measurement A is defined, and a second horizontal dimension measurement C (best shown in FIG. 2), which is defined within the same plane as the first horizontal dimension measurement B. It is conceivable and contemplated that the machine 100 may embody other dimension measurements defined in other planes, such as, for example, dimension measurements defined in planes oriented at a predetermined non-orthogonal angle or degree (e.g. a forty-five degree angle) relative to either the horizontal or vertical planes, without departing from the scope of this disclosure.

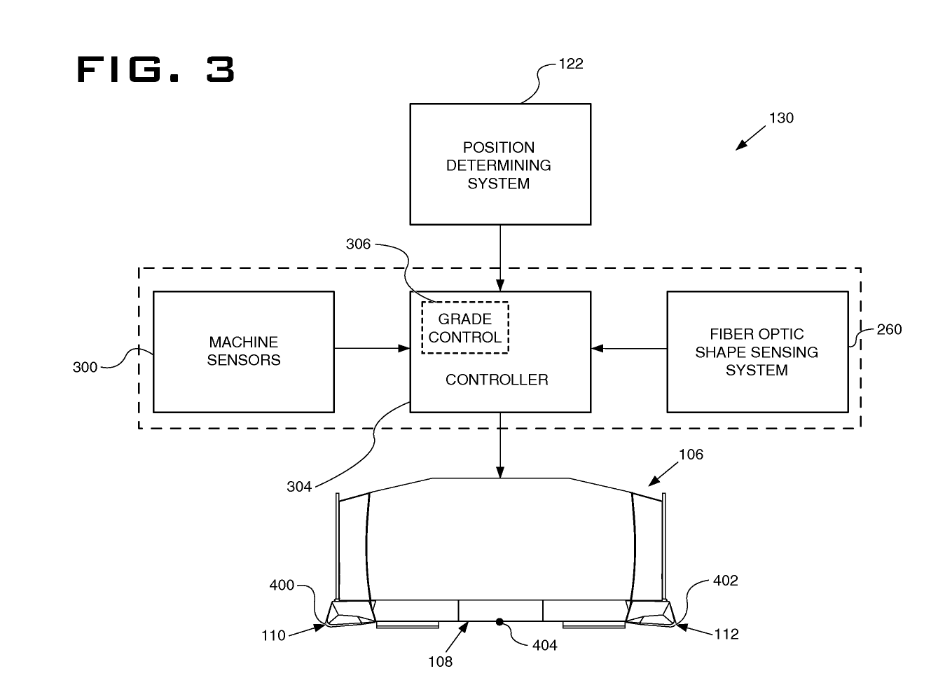

As illustrated in FIG. 3, the implement control system 130 includes at least one sensor 300 operatively connected to or associated with the machine 100, such as, for example, an inclination sensor, at least one sensor 302 operatively connected to or associated with the implement 106, such as, for example, a rotation angle sensor, translational motion, or a gravitational referenced inclination sensor, or an inertial measurement unit (IMU) 308, and a controller 304. An IMU 308 is an electronic device that measures and reports a machine's velocity, orientation, and gravitational forces, using a combination of accelerometers and gyroscopes. The controller 304 is adapted to receive inputs from the input device, the position determining system 122, and the sensors 300, 302. The implement control system 130 is further adapted to control or direct the movement of the implement 106 based on the inputs from the input device, the position determining system 122, and the sensors 300, 302. One such sensor 300 may be a ground speed sensor such as a RADAR unit configured to detect ground speed. In another aspect of the current disclosure, ground speed may be calculated from Doppler GPS.

For example, the controller 304 may direct the implement 106 to move to a predetermined or target position in response to an input signal received from a grade control system 306, which may direct the implement 106 to cut to a predetermined or target grade profile. To direct the implement 106 to move precisely in response to an automatically determined movement signal, such as, for example, the grade control system 306 signal, the controller 304 may calibrate the grade control system 306 using the measurements A, B, and C to establish initial machine conditions. The controller 304 may also calibrate the machine sensors 300 and/or the implement sensors 302 using the measurements A, B, and C.

As illustrated in FIG. 3, the controller 304 may be adapted to determine a position of one or more desired points 400, 402 on the cutting edge 108 of the implement 106. The one or more desired points 400, 402 may be representative of a portion of the implement 106. In the illustrated embodiment, the one or more desired points 400, 402 are representative of the first edge 110 and the second edge 112 respectively. Alternatively or additionally, in some embodiments, a center point 404 disposed between the first edge 110 and the second edge 112 may represent a desired position.

The controller 304 may be further adapted to determine the measurement A, representative of the vertical dimension of the machine 100, based in part on the reference position 132 and the one or more desired points 400, 402. The controller 304 may also be adapted to determine the measurement B and/or the measurement C, which are representative of the horizontal dimensions of the machine 100, based in part on the reference position 132 and the one or more desired points 400, 402. Alternatively, or additionally, the controller 304 may be adapted to determine a measurement (not shown) representative of the distance from the reference position 132 to the one or more desired points 400, 402. The controller 304 may derive or determine the measurements A, B, and C using known algorithms, such as, for example, vector math, and/or using customized algorithms, for example, customized kinematic equations.

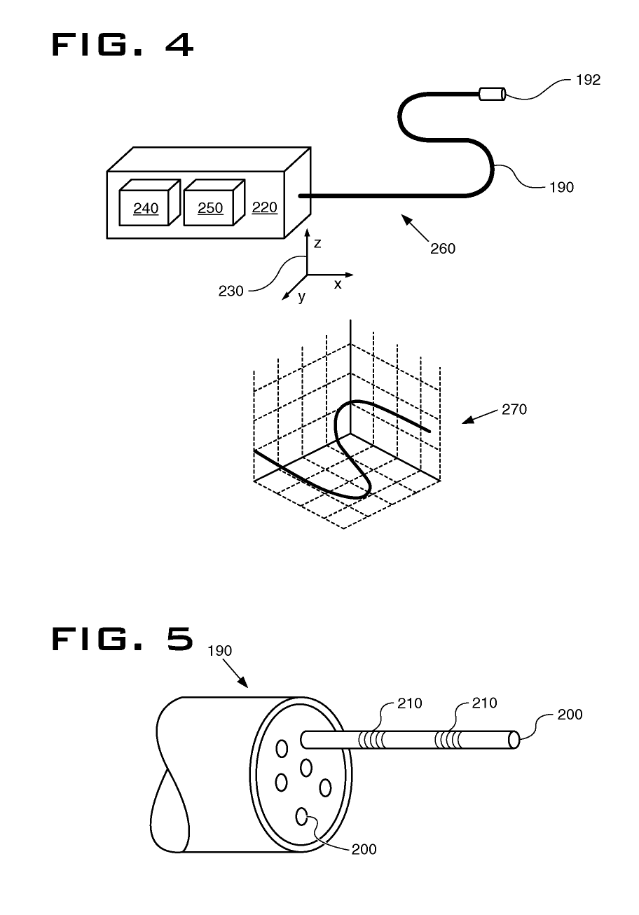

FIG. 4 is a view of fiber optic shape sensing system 260. The fiber optic shape sensing system 260 includes a fiber bundle 190, an interrogation module 220, and a signal condition module 240. A representative reference frame 230 is shown, which is fixed to the interrogation module 220. The fiber bundle 190 is joined to the interrogation module 220 at a proximal end and includes a fiber termination 192 at a distal end. Interrogation module 220 is a device that is configured to transmit light to the fiber bundle 190 and receive reflected light from the fiber bundle 190 and provide 3D shape reconstruction 270. Information from the 3D shape reconstruction 270 is provided to signal condition module 240 which provides the location of a t least one position of the fiber bundle 190 relative to the reference frame 230.

FIG. 5 is a view of an optical fiber bundle 190 including a multitude of fiber cores 200. A detailed view of a fiber core 200 is included for the sake of illustration. Two fiber Bragg gratings (FBGs) 210 are shown formed into the fiber core 100 which are illustrative of many such FBGs 210 typically formed along the full length of a fiber core 200.

It is known that each of the FBGs 210 may be interrogated for strain information. A fiber bundle 190 may contain two or more fiber cores 200 and the FBGs 210 in each fiber core 200 are located at the same length along the fiber core 200. As the index of refraction of a medium depends on stress and strain, the bend direction and axial twist of the fiber core 200 may be determined from the strains in each core's FBG 210. From the strain information from each fiber core 200 at each FBG 210 location along the length of the fiber core 200 the shape of the fiber core 200 can be determined.

A curvilinear coordinate system is defined with an origin at the proximal end of the fiber bundle 190 where it is joined to an interrogation module 220. A fiber termination 192 is located at the distal end of the fiber bundle 190. A Cartesian coordinate system is also defined as a base reference frame 230 having an origin coincident with the curvilinear coordinate system's origin.

To determine the approximate shape of the fiber core 200, the strain information measured at each FBG 210 location is used to determine the approximate local bend for the length of fiber core 200 without FBG 210. For example, the strain information from three fiber cores 200 in a fiber bundle 190 is used to compute the plane and the bend radius of the fiber bundle 190. Segments are defined at various locations along the fiber bundle 190, and each segment ends at a co-located ring of FBG 210 in the three fiber cores 200. Given the Cartesian x,y,z position of the FBG 210 ring being processed (i.e., the segment end position), the position of the next FBG 210 ring can be computed with simple geometry. The position of the first segment's end location with respect to the base frame 230 is then determined from the first segment's bend information. Next, strain information for the second segment is processed to determine the second segment's bend. The second segment's bend information is combined with the position of the first segment's end location to determine the second segment's end location position with respect to the base frame. Thus the position of each segment end location is determined with respect to the base frame 230, and the position information is used to determine the approximate shape of the fiber bundle 190. Accordingly, the position of multiple points along the fiber bundle 190, including the fiber termination 192, relative the base frame 230 can be determined. An example of a 3D representation of the shape of the fiber bundle 190 is shown in FIG. 4.

A second use of FBG 210 for the present disclosure employs Optical Frequency Domain Reflectometry (OFDR). This approach uses low reflectivity gratings all with the same center wavelength and a tunable laser source. The FBGs 210 may be located on a single optical fiber core 200. This allows hundreds of strain sensors to be located down the length of the fiber core 200. This configuration allows strain measurements to be acquired at much higher spatial resolution than other current sensor technologies, making it flexible enough to employ a user-selected grating density depending on the type of application.

The principles of operation of the fiber shape sensing concept are known and can be found in U.S. Pat. No. 8,116,601 to Prisco, issued Feb. 14, 2012, entitled “Fiber optic shape sensing,” U.S. Pat. No. 20,130,308,138 to ‘T Hooft et al., issued Nov. 21, 2013, entitled “FIBER OPTIC SENSOR FOR DETERMINING 3D SHAPE,” and U.S. Pat. No. 7,715,994 to Richards et al., issued May 11, 2010, entitled “Process for using surface strain measurements to obtain operational loads for complex structures.”

Referring to FIG. 4, the interrogation module 220 is a device that is configured to transmit light to the fiber bundle 90 and receive reflected light from the fiber bundle 190. The interrogation module 220 may use a laser as a light source. The interrogation module 220 may also contain a microprocessor, a storage medium such as magnetic, optical, or solid state, and input/output circuitry. The interrogation module 220 may also include a 3D shape reconstructor 250. A 3D shape reconstructor 250 is a system or device configured to receive reflection spectrum data from the interrogation module 220 and generate local strain data as a function of position along fiber bundle 190. Accordingly, the 3D shape reconstructor 250 translates the reflection spectrum data into a 3D shape of the fiber bundle 190. The interrogation module 220 may also include a signal conditioning module 240. A signal conditioning module 240 is a system or device configured to receive the reflection spectrum data from the interrogation module 220 and provide a signal indicative of the lift, tilt, or yaw angle of implement 106. The signal conditioning module 240 may contain a 3D shape reconstructor 250. The signal conditioning module 240 may also contain microprocessor, a storage medium such as magnetic, optical, or solid state, and input/output circuitry.

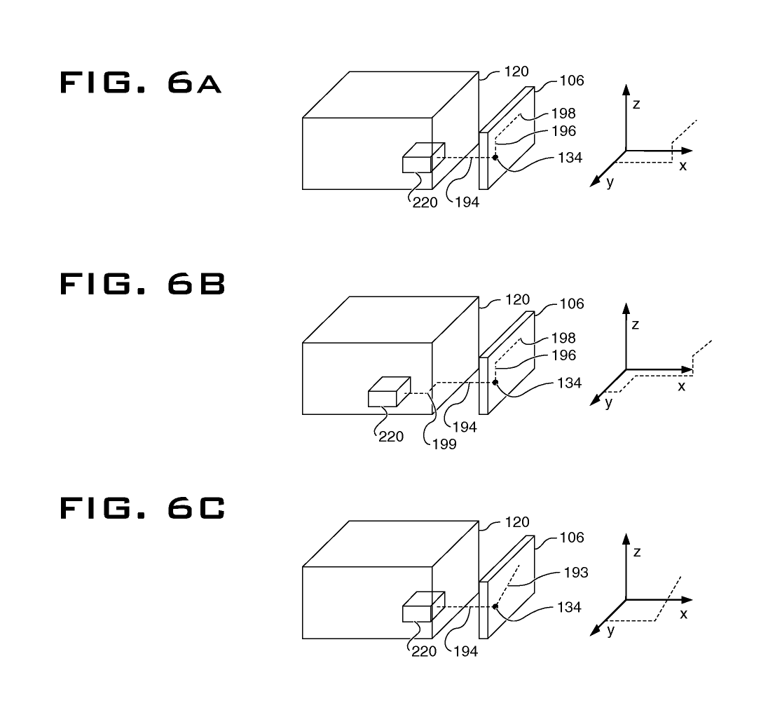

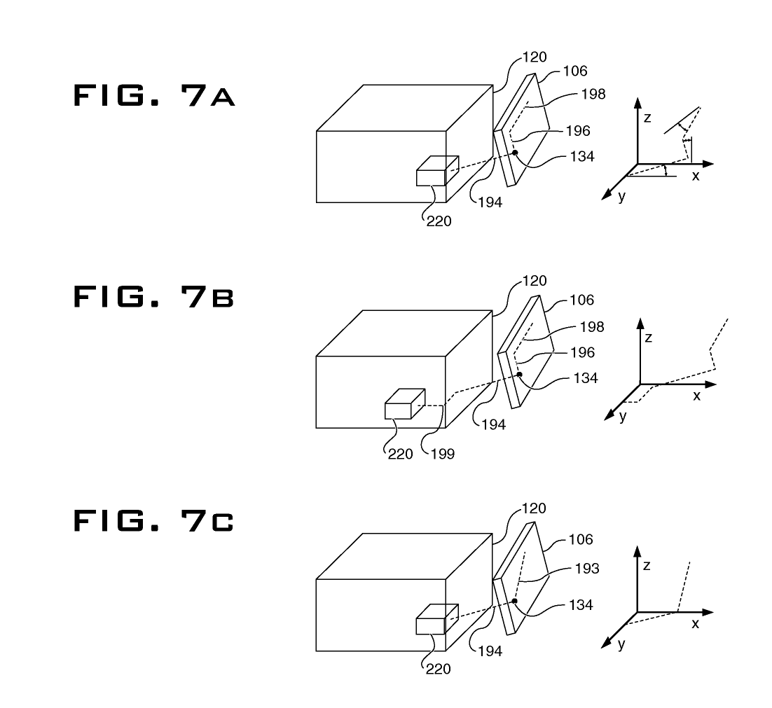

A fiber optic shape sensing system 260 as applied to an implement 106 of a machine 100 is illustrated in FIGS. 6 and 7. The interrogation module 220 is in communication with the position determining system 122 and the implement control system 130. The interrogation module 220 is mounted to the machine frame 120 such that they are fixed to the same reference frame 230. The interrogation module 220 can be mounted to a frame member of the machine frame 120 or a guard or bracket such that the interrogation module 220 is mechanically grounded to the machine frame 120. Fiber bundle 190 is joined to the interrogation module 220 at a proximal end and to the implement 106 at a distal end. The proximal end of the fiber bundle 190 may of course be attached to a frame, arm, or linkage of the implement 106 without departing from the scope of the current disclosure. The fiber bundle 190 may be attached to an implement reference point 134 that is located on the implement 106. The implement reference point 134 is any fixed point located on the implement 106 that makes a convenient point to determine movement of the implement 106 relative to the machine frame 120.

As shown in FIGS. 1 and 2, the location the position determining system 122 relative to the interrogation module 220 on machine frame 120 is known. The relative distance is fixed and known and can be represented by dimensions D, E, and F. These dimensions may be values entered into the memory of controller 304 by the factory or may be entered by a technician during a calibration process.

The fiber bundle 190 is comprised of a connecting section 194 that spans the distance between the machine frame 120 and the implement 106. The relative position of the proximal end and distal end of the connecting section 194 will change as the implement 106 is lifted and lowered. The change in relative position can be determined by the interrogation module 220 and a signal corresponding to the position of the implement 106 relative to the machine frame 120 is generated and communicated to the position determining system 122 and the controller 304. The position of the implement 106 relative to the machine frame 120 is thereby determined at any position as the implement 106 is lifted and lowered.

The fiber bundle 190 may be further comprised of a vertical section 196 that is mounted to the implement 106. The relative position of the proximal end and distal end of the vertical section 196 will change as the implement 106 is tilted fore and aft or rolled. The change in relative position can be determined by the interrogation module 220 and a signal corresponding to the position of the implement 106 relative to the machine frame 120 is generated and communicated to the position determining system 122 and the controller 304. The tilt position of the implement 106 relative to the machine frame 120 is thereby determined at any position as the implement 106 is tilted fore and aft or rolled.

The fiber bundle 190 may be further comprised of a horizontal section 198. The relative position of the proximal end and distal end of the horizontal section 198 will change as the implement 106 is angled about the yaw axis or rolled. The change in relative position can be determined by the interrogation module 220 and a signal corresponding to the position of the implement 106 relative to the machine frame 120 is generated and communicated to the position determining system 122 and the controller 304. The yaw position of the implement 106 relative to the machine frame 120 is thereby determined at any position as the implement 106 is angled about the yaw axis or rolled.

It will be understood by a person skilled in the art that the vertical section 196 and the horizontal section 198 can be positioned in any order along the fiber bundle 190.

In one aspect of the current disclosure, the fiber bundle 190 may be comprised of a diagonal section 193 rather than a vertical section 196 and a horizontal section 198. The proximal end of the diagonal section 193 is joined to the distal end of the connecting section 194 and the distal end of diagonal section 193 is located at a different location on the implement 106.

The distal end of the diagonal section 193 should be placed a distance from the proximal end of the diagonal section 193 along the plane defined by the implement 106 (y-z plane in FIGS. 6 and 7). The location of the distal end of diagonal section 193 should be such that it is displaced by a measurable distance along each axis of the plane defined by the implement 106. The length of the diagonal section 193 can be any number of lengths, but should be long enough such that tilt, roll, and yaw angle movement of the implement 106 can be measured by the fiber optic shape sensing system 260.

In one aspect of the current disclosure, the fiber bundle 190 may be comprised of a body section 199 as illustrated in FIGS. 6 and 7. The body section 199 is attached to the machine frame 120 and provides an additional reference to the fiber optic shape sensing system 260. Comparison of multiple points along the body section 199 to the vertical section 196, horizontal section 198, and diagonal section 193 may be a convenient way of determining the position of the implement 106. As recognized by a person skilled in the art, the body section 199 may include a horizontal, vertical, or diagonal element as is required by the fiber optic shape sensing system 260.

The fiber bundle 190 may be routed any number of ways, such that the interrogation module 220 is mounted to the machine frame 120 and the distal end of the fiber bundle 190 is mounted to the implement 106. Examples include routing the fiber bundle 190 along a push arm 140, the tag link (not shown), or along any harness or hydraulic line that runs between the machine frame 120 and the implement 106.

The fiber bundle 190 may be protected in a hardened shroud at any point along its length. Where the fiber bundle 190 may span a distance that is unsupported by rigid structures, such as is the case with the connecting section 194, the fiber bundle 190 may be protected by a hardened flexible conduit as is known to be used with wiring harnesses and hydraulic lines. The fiber bundle 190 may also include sections that provide strain relief such as coiled sections, curved sections, support springs, and relief bushings.

In one aspect of the current disclosure, the interrogation module 220 and position determining system 122 may be mounted at the same location on the machine frame 120 and may be attached to one another. Such an arrangement may simplify calculations and calibration needed by controller 304 and the fiber optic shape sensing system 260.

According to the current disclosure, the controller 304 is adapted to determine or derive the measurements A, B, and C from the position signals received from the position determining system 122. The controller 304, for example, may be adapted to determine a position of a reference position 132 on the machine 100 in the site coordinate system 123. The reference position 132 or reference position may be representative of an absolute position of the position determining system 122 mounted to the machine frame 120.

As illustrated in FIG. 3, the controller 304 may be adapted to determine a position of one or more desired points 400, 402 on the cutting edge 108 of the implement 106. The one or more desired points 400, 402 may be representative of a portion of the implement 106. In the illustrated embodiment, the one or more desired points 400, 402 are representative of the first edge 110 and the second edge 112 respectively. Alternatively or additionally, in some embodiments, a center point 404 disposed between the first edge 110 and the second edge 112 may represent a desired position.

### INDUSTRIAL APPLICABILITY

A fiber optic shape sensing system 260 is adapted to determine the position and orientation of an implement 106 relative to a machine frame 120. A position determining system 122 is mounted to the machine frame 120 in a place where the GPS receiver associated with the position determining system 122 has a clear line of sight to space. The position determining system 122 may be mounted to the machine's cab 104 or to a roll-over protection system (ROPS) that is integrated into the cab 104. In either case, the position determining system 122 is considered to be fixed and mechanically grounded to the machine frame 120. In one aspect of the current disclosure, the position determining device 122 may include two or more GPS receivers. The locations of the multiple GPS are fixed and known and their locations may be provided to the controller 304 and fiber optic shape sensing system 260.

The fiber optic shape sensing system 260 includes a fiber bundle 190 that is attached to implement 106. There are various ways to route and attach the fiber bundle 190 to the implement 106 as can be understood by a person skilled in the art. A few such examples are included in, but not limited to, the description and figures of the current disclosure. The routing and attachment method may be chosen depending on the application and may be physically done in a location such as a factory. Whichever routing and attachment arrangement is chosen, the location of each position of the fiber bundle 190, and thereby each FBG 210, is known relative to the implement 106. Therefore, as the orientation of the implement 106 changes as it lifts, tilts, and yaws, the shape of the fiber bundle 190 changes in relation to the interrogation module 220. The shape of the fiber bundle 190 can then be determined and communicated to controller 304. Therefore, the position and orientation of the implement 106 relative to the machine frame 120 can be determined.

The locations of the position determining system 122 and the interrogation module 220 are fixed and known. The locations are known by the designers of the machine frame 120 and the locations are physically fixed at a location such as a factory. The locations can be input into the controller 304. Therefore, the position and orientation of the implement 106 relative to the position determining system 122 can be determined. Furthermore, the position and orientation of the implement 106 relative to the site coordinate system 123 can be determined.

Desired points 400, 402 on the implement 106 may correspond to a cutting or engaging edge. The locations of the desired points 400, 402 in the implement 106 are fixed and known. The positions of the desired points 400, 402 relative to the machine frame 120 and the site coordinate system 123 can be determined. The implement control system 130 can therefore position the desired points 400, 402 at a predetermined location on the site coordinate system 123.

A predetermined surface contour or final grade of a work site may be defined by a site designer or back office and communicated to the implement control system 130. The machine communication system may connect to a site management system and to the implement control system 130 and may include bidirectional transfer of information about the machine 100 and worksite. The implement control system 130 can therefore position the implement 106 in the proper position to achieve the predetermined surface contour or final grade of the work site.

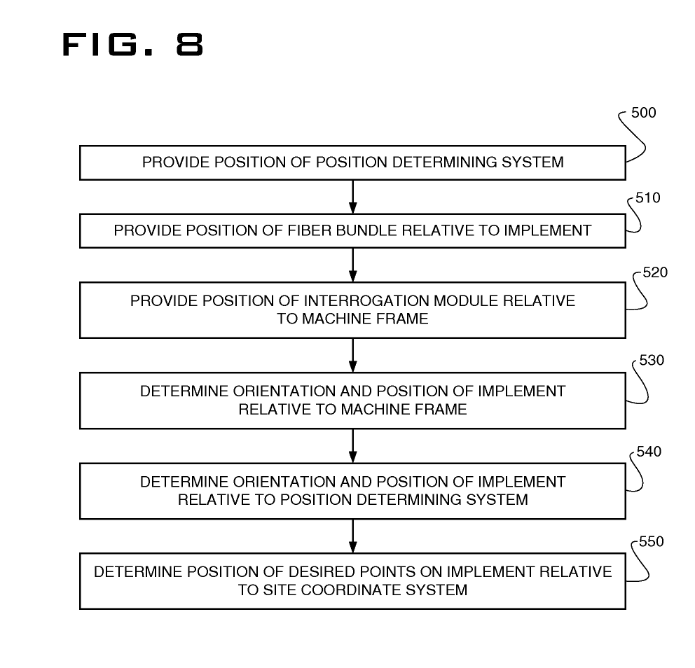

FIG. 8 illustrates exemplary steps to determine the position and orientation of an implement 106 relative to a machine frame 120 according to the current disclosure. In step 500 the position of position determining system 122 relative to the machine frame 120 is provided to the implement control system 130. In step 510 the position of the fiber bundle 190 relative to the implement 106 is provided to the implement control system 130. In step 520 the position of the interrogation module 220 relative to the machine frame 120 is provided to implement control system 130. In step 530 the orientation of the implement 106 relative to the machine frame 120 is determined In one aspect of the current disclosure, a further step 540 may include determining the orientation and position of the implement 106 relative to the position determining system 122. A further step 550 may include determining the position of desired points 400, 402 relative to the site coordinate system 123.

What is claimed is:

1. A system for determining a position and orientation of an implement relative to a frame of a machine comprising:
said implement being attached to and moveable relative to said machine,
a fiber optic shape sensing system associated with said implement comprising:
an interrogation module mounted to said machine frame,
a reference frame fixed to said interrogation module and machine frame, and
a fiber bundle joined to said interrogation module at a proximal end and to said implement at a distal end,
wherein said interrogation module is configured to receive strain information from said fiber bundle and compute the location of at least one position of said fiber bundle that is associated with said implement relative to the reference frame.

2. The system of claim 1 wherein the interrogation module is further configured to compute the locations of multiple positions of the fiber bundle indicative of a lift position of said implement.

3. The system of claim 2 wherein the interrogation module is further configured to compute the locations of multiple positions of the fiber bundle indicative of a tilt and a yaw angle position of said implement.

4. The system of claim 1 wherein said fiber bundle includes a horizontal segment associated with said implement.

5. The system of claim 1 wherein said fiber bundle includes a vertical segment associated with said implement.

6. The system of claim 1 wherein said fiber bundle includes a diagonal segment associated with said implement.

7. The system of claim 1 wherein said fiber optic shape sensing system further comprises an implement reference point.

8. The system of claim 1 further comprising:
a position determining system mounted to said machine frame at a fixed known distance from said interrogation module,
a controller configured to:
receive a signal from the position determining system indicative of a reference point position,
receive a signal indicative of ground speed from said position determining system,
receive a signal indicative of machine pitch,
receive a signal indicative of a computed location of at least one position of the fiber bundle that is associated with said implement relative to the reference frame,
determine the position of a desired point on the implement in a site coordinate system compensating for pitch of the machine and translational movement of the machine as a function of the reference point position signal, the computed location of at least one position of the fiber bundle, the ground speed signal, and the machine pitch signal.

9. A method for determining the position and orientation of an implement relative to a frame of a machine comprising:
said implement being attached to and moveable relative to said machine,
providing a fiber optic shape sensing system associated with said implement comprising:
an interrogation module mounted to said machine frame,
a reference frame fixed to said interrogation module and machine frame, and
a fiber bundle joined to said interrogation module at a proximal end and to said implement at a distal end,
receiving reflection spectrum information from the fiber bundle in said interrogation module, and
computing the location of at least one position of said fiber bundle that is associated with said implement relative to the reference frame.

10. The method of claim 9 further comprising computing the locations of multiple positions of the fiber bundle indicative of a lift position of said implement.

11. The method of claim 10 further comprising computing the locations of multiple positions of the fiber bundle indicative of a tilt and a yaw angle position of said implement.

12. The method of claim 10 wherein said fiber bundle includes a horizontal segment associated with said implement.

13. The method of claim 10 wherein said fiber bundle includes a vertical segment associated with said implement.

14. The method of claim 10 wherein said fiber bundle includes a diagonal segment associated with said implement.

15. The method of claim 9 further comprising:
providing a position determining system mounted to said machine frame at a fixed known distance from said interrogation module,
receiving, in a controller, a signal from the position determining system indicative of a reference point position,
receiving, in the controller, a signal indicative of ground speed from said position determining system,
receiving, in the controller, a signal indicative of machine pitch,
receiving, in the controller, a signal indicative of a computed location of at least one position of the fiber bundle that is associated with said implement relative to the reference frame,
determining, in the controller, the position of a desired point on the implement in a site coordinate system compensating for pitch of the machine and translational movement of the machine as a function of the reference point position signal, the computed location of at least one position of the fiber bundle, the ground speed signal, and the machine pitch signal.

16. A machine equipped with a system for determining the position and orientation of an implement relative to a frame of the machine comprising:
a power source,
a ground engaging mechanism,
an implement attached to and moveable relative to said machine,
a fiber optic shape sensing system associated with said implement comprising:
an interrogation module mounted to said machine frame,
a reference frame fixed to said interrogation module and machine frame, and
a fiber bundle joined to said interrogation module at a proximal end and to said implement at a distal end,
wherein said interrogation module is configured to receive strain information from said fiber bundle and compute the location of at least one position of said fiber bundle that is associated with said implement relative to the reference frame.

17. The system of claim 16 wherein the interrogation module is further configured to compute the locations of multiple positions of the fiber bundle indicative of a lift position of said implement.

18. The system of claim 17 wherein the interrogation module is further configured to compute the locations of multiple positions of the fiber bundle indicative of a tilt and a yaw angle position of said implement.

19. The system of claim 1 wherein said fiber bundle includes a horizontal segment associated with said implement.

20. The machine of claim 16 further comprising:
a position determining system mounted to said machine frame at a fixed known distance from said interrogation module,
a controller configured to:
receive a signal from the position determining system indicative of a reference point position,
receive a signal indicative of ground speed from said position determining system,
receive a signal indicative of machine pitch,
receive a signal indicative of a computed location of at least one position of the fiber bundle that is associated with said implement relative to the reference frame,
determine the position of a desired point on the implement in site a coordinates system compensating for pitch of the machine and translational movement of the machine as a function of the reference point position signal, the computed location of at least one position of the fiber bundle, the ground speed signal, and the machine pitch signal.
